(19) United States
(12) Patent Application Publication
(10) Pub. No.: US 2026/0058075 A1
(43) Pub. Date: Feb. 26, 2026

(54) BUTTON STRUCTURE

(71) Applicant: CHENG UEI PRECISION INDUSTRY CO., LTD., New Taipei City (TW)

(72) Inventors: TSUNG-SHIH LEE, New Taipei City (TW); YI HSU, New Taipei City (TW)

(21) Appl. No.: 19/050,093

(22) Filed: Feb. 10, 2025

(30) Foreign Application Priority Data
Aug. 26, 2024 (CN) 202422078087.6

(51) Int. Cl. H01H 13/14; H01H 13/10

(52) U.S. Cl. CPC H01H 13/14; H01H 13/10

(57) ABSTRACT

A button structure includes a plurality of supporting elements, an elastic element, a plurality of conductive elements, a circuit board, and a plurality of key caps mounted around the plurality of the supporting elements. Each supporting element has a base portion. The elastic element is disposed to bottom surfaces of the plurality of the supporting elements. Several portions of a top surface of the elastic element are recessed downward to form a plurality of concave portions. Middles of top surfaces of the plurality of the concave portions extend upward to form a plurality of elastic covers. The plurality of the conductive elements are disposed to top surfaces of insides of the plurality of the elastic covers. The circuit board is disposed to a bottom surface of the elastic element. The plurality of the conductive elements are disposed between the elastic element and the circuit board.

### CROSS REFERENCE TO RELATED APPLICATIONS

The present application is based on, and claims priority from, China Patent Application No. 202422078087.6, filed Aug. 26, 2024, the disclosure of which is hereby incorporated by reference herein in its entirety.

### BACKGROUND OF THE INVENTION

### Field Of The Invention

The present invention generally relates to a button structure, and more particularly to a button structure which prevents a mutual interference among electronic circuits and improves a sensitivity of the button structure.

### Description of Related Art

Generally, a current game controller has an action button. The action button is an ABXY button. The action button has a spring. The spring of the action button of the current game controller is used as a conductor. The spring of the action button of the current game controller is soldered to a circuit board. The spring of the action button of the current game controller is clamped between a key cap and a rubber to control a game function triggering. Nonetheless, the action button of the current game controller needs using frequently, so the spring of the current game controller exists a short usage life issue.

A conventional game controller includes a shell, a circuit board and a durable button structure. The circuit board is disposed in the shell. The button structure is disposed at the shell. The circuit board is equipped with a plurality of conductive switches. The plurality of the conductive switches are connected with the circuit board. The button structure includes a key holder, a middle layer and a plurality of key caps. The key holder is disposed to a top surface of the circuit board. The key holder is supported by the top surface of the circuit board. The middle layer is disposed to a top surface of the key holder. The plurality of the key caps are disposed to a top surface of the middle layer. The middle layer is made of a conductive silicone material. The middle layer has a plurality of middle layer holes, a plurality of button pillars and a plurality of elastic deformation portions. The plurality of the middle layer holes penetrate through a top surface and a bottom surface of the middle layer. Each button pillar is formed at a middle of one middle layer hole. The plurality of the key caps are supported on upper ends of the plurality of the button pillars. The plurality of the button pillars are disposed to tops of the plurality of the conductive switches of the circuit board. Each elastic deformation portion is formed between the one middle layer hole and an outer surface of one button pillar.

However, the plurality of the button pillars are integrally molded to the middle layer, when the button structure is operated to be pressed downward, a plurality of electronic circuits of the plurality of the button pillars are easily interfered with one another, so a game function is affected. Furthermore, the middle layer and the circuit board are without being mutually conductive, so that a sensitivity of the button structure is affected.

Thus, it is essential to provide an innovative button structure which prevents a mutual interference among electronic circuits and improves a sensitivity of the innovative button structure.

### BRIEF SUMMARY OF THE INVENTION

An object of the present invention is to provide a button structure which prevents a mutual interference among electronic circuits and improves a sensitivity of the button structure. The button structure includes a plurality of supporting elements, an elastic element, a plurality of conductive elements, a circuit board and a plurality of key caps. Each supporting element has a base portion. The base portion extends upward to form a connecting portion. The connecting portion extends upward to form a top portion. The elastic element is disposed to bottom surfaces of the plurality of the supporting elements. Several portions of a top surface of the elastic element are recessed downward to form a plurality of concave portions. The base portions of the plurality of the supporting elements are disposed to the plurality of the concave portions. Middles of top surfaces of the plurality of the concave portions extend upward to form a plurality of elastic covers. The connecting portions of the plurality of the supporting elements surround the plurality of the elastic covers. The plurality of the conductive elements are disposed to top surfaces of insides of the plurality of the elastic covers. The circuit board is disposed to a bottom surface of the elastic element. The plurality of the conductive elements are disposed between the elastic element and the circuit board. The plurality of the key caps are mounted around the plurality of the supporting elements. The plurality of the key caps surround the top portions of the plurality of the supporting elements.

Another object of the present invention is to provide a button structure. The button structure includes a plurality of supporting elements, an elastic element, a circuit board and a plurality of key caps. Each supporting element has a connecting portion. The connecting portion extends upward to form a top portion. One side of a bottom surface of the connecting portion extends outward to form an extending portion. A lower surface of the extending portion extends downward to form a protruding pillar. The elastic element is disposed to bottom surfaces of the plurality of the supporting elements. The elastic element has a plurality of first through holes penetrating through a top surface and a bottom surface of the elastic element. The protruding pillars of the plurality of the supporting elements pass through the plurality of the first through holes. The circuit board is disposed to the bottom surface of the elastic element. The circuit board has a plurality of second through holes and a plurality of conductive portions. The plurality of the conductive portions are disposed in the circuit board, and the plurality of the conductive portions are exposed to a top surface of the circuit board. The plurality of the second through holes penetrate through the top surface of the circuit board. Each second through hole is formed at a middle of one conductive portion. The plurality of the second through holes penetrate through top surfaces of the plurality of the conductive portions. The plurality of the first through holes are corresponding to the plurality of the second through holes. The protruding pillars of the plurality of the supporting elements pass through the plurality of the first through holes and the plurality of the second through holes. The lower surfaces of the extending portions of the plurality of the supporting elements contact with top surfaces of the plurality of the conductive portions. The plurality of the key caps surround the top portions of the plurality of the supporting elements.

Another object of the present invention is to provide a button structure. The button structure includes a plurality of conductive supporting elements, an insulative elastic element, a circuit board and a plurality of key caps. Each conductive supporting element has a connecting portion. The connecting portion extends upward to form a top portion. One side of the connecting portion extends outward to form an extending portion. A lower surface of the extending portion extends downward to form a protruding pillar. The plurality of the conductive supporting elements are integrated with the insulative elastic element by virtue of an injection molding technology. The insulative elastic element is disposed to bottom surfaces of the plurality of the conductive supporting elements. A top of the insulative elastic element projects into the plurality of the conductive supporting elements. The insulative elastic element has a plurality of first through holes penetrating through a top surface and a bottom surface of the insulative elastic element. The protruding pillars of the plurality of the conductive supporting elements pass through the plurality of the first through holes. The circuit board is disposed to the bottom surface of the insulative elastic element. The circuit board has a plurality of second through holes penetrating through a top surface of the circuit board. The plurality of the first through holes are corresponding to the plurality of the second through holes. The protruding pillars of the plurality of the supporting elements pass through the plurality of the first through holes and the plurality of the second through holes. The plurality of the second through holes are made of conductive materials. The protruding pillars of the plurality of the conductive supporting elements are electrically connected with the plurality of the second through holes. The plurality of the key caps surround the top portions of the plurality of the insulative supporting elements.

As described above, the plurality of the supporting elements have conductive characteristics, bottom surfaces of a plurality of protruding portions contact with the top surfaces of the plurality of the conductive portions, the protruding pillars of the plurality of the supporting elements are fastened in the plurality of the second through holes, the walls of the plurality of the second through holes are made of conductive materials, the plurality of the second through holes are electrically connected with the plurality of the conductive portions, and the protruding pillars of the plurality of the supporting elements contact with the plurality of the conductive portions, so the plurality of the supporting elements contact with the circuit board, the plurality of the supporting elements are electrically connected with the circuit board, and the plurality of the supporting elements have a touch sensing capability. When the button structure is pressed downward, the plurality of the conductive elements contact with the circuit board, and the plurality of the conductive elements are electrically connected with the circuit board, when the button structure is touched, the plurality of the supporting elements are electrically connected with the circuit board to make the plurality of the supporting elements have the touch sensing capability. Furthermore, the elastic element separates the plurality of the supporting elements and the plurality of the conductive elements to prevent causing a mutual interference among the plurality of the supporting elements and the plurality of the conductive elements, the plurality of the concave portions separate the plurality of the supporting elements to prevent causing a mutual interference among the plurality of the supporting elements, and the plurality of the elastic covers separate the connecting portions and the top portions of the plurality of the supporting elements, and the plurality of the conductive elements to prevent causing the mutual interference among the plurality of the supporting elements and the plurality of the conductive elements. As a result, the button structure prevents a mutual interference among electronic circuits and improves a sensitivity of the button structure which has the touch sensing capability.

### BRIEF DESCRIPTION OF THE DRAWINGS

The present invention will be apparent to those skilled in the art by reading the following description, with reference to the attached drawings, in which:

FIG. 1 is a perspective view of a button structure in accordance with a preferred embodiment of the present invention;

FIG. 2 is an exploded view of the button structure of FIG. 1;

FIG. 3 is a diagrammatic drawing of the button structure of FIG. 1;

FIG. 4 is a sectional diagram of the button structure along a line IV-IV of FIG. 3; and

FIG. 5 is a sectional diagram of the button structure along a line V-V of FIG. 3.

### DETAILED DESCRIPTION OF THE INVENTION

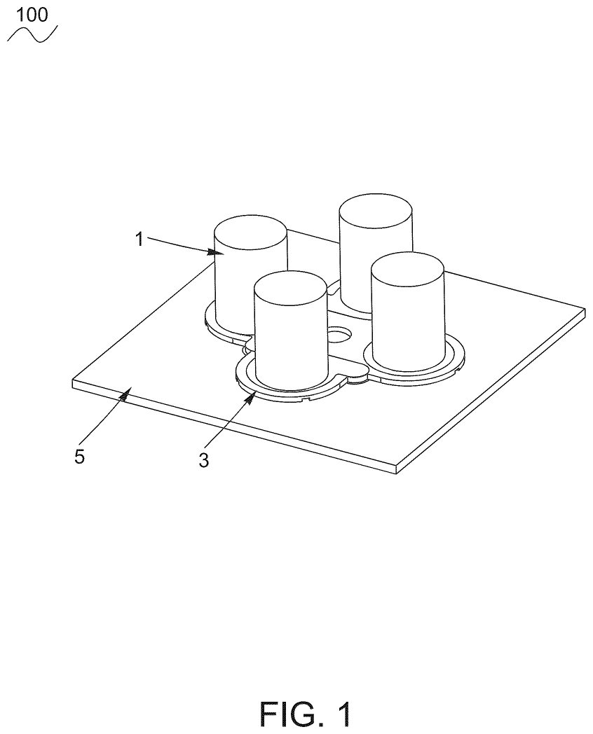

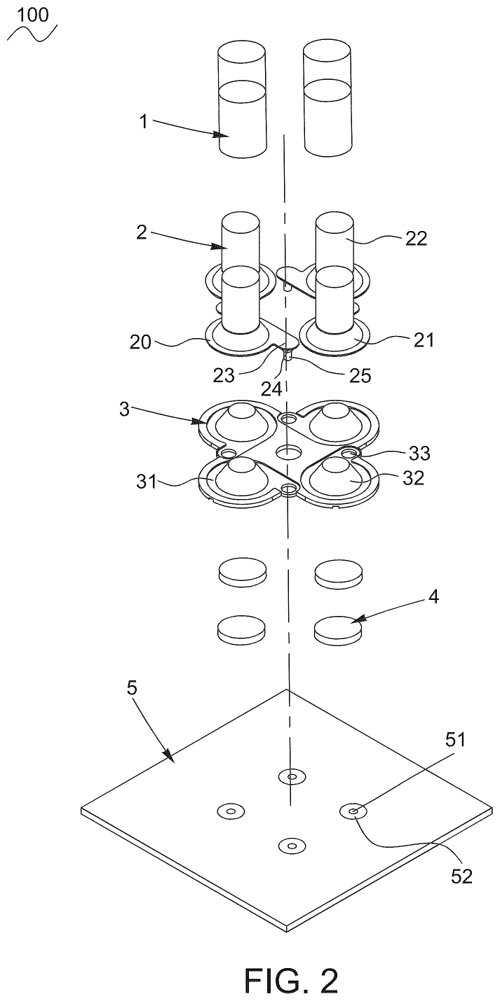

With reference to FIG. 1 and FIG. 2, a button structure 100 in accordance with a preferred embodiment of the present invention is shown. The button structure 100 includes a plurality of key caps 1, a plurality of supporting elements 2, an elastic element 3, a plurality of conductive elements 4 and a circuit board 5.

The plurality of the key caps 1 are mounted around the plurality of the supporting elements 2. The plurality of the supporting elements 2 contact with the circuit board 5. The plurality of the supporting elements 2 are electrically connected with the circuit board 5. The plurality of the supporting elements 2 and the circuit board 5 are electrically conductive, so the plurality of the supporting elements 2 have a touch sensing capability. The elastic element 3 is disposed to bottom surfaces of the plurality of the supporting elements 2. A top of the elastic element 3 projects into the plurality of the supporting elements 2. The elastic element 3 separates the plurality of the supporting elements 2 and the plurality of the conductive elements 4 to prevent causing a mutual interference among the plurality of the supporting elements 2 and the plurality of the conductive elements 4. The plurality of the conductive elements 4 are disposed to a bottom surface of the elastic element 3. The circuit board 5 is disposed to the bottom surface of the elastic element 3. The plurality of the conductive elements 4 are disposed between the elastic element 3 and the circuit board 5.

Referring to FIG. 1 and FIG. 2 again, when the button structure 100 is unused, the plurality of the conductive elements 4 keep a distance from the circuit board 5. When the button structure 100 is pressed downward, the plurality of the conductive elements 4 contact with the circuit board 5, the plurality of the conductive elements 4 are electrically connected with the circuit board 5, and the plurality of the conductive elements 4 and the circuit board 5 are mutually conductive. When the button structure 100 is touched, the plurality of the supporting elements 2 are electrically connected with the circuit board 5 to make the plurality of the supporting elements 2 have the touch sensing capability. In the preferred embodiment, the plurality of the supporting elements 2 are integrated with the elastic element 3 by virtue of an injection molding technology.

In the preferred embodiment, the plurality of the supporting elements 2 have conductive characteristics. The plurality of the supporting elements 2 are made of conductive rubbers. The plurality of the conductive elements 4 are made of the conductive rubbers. In a concrete implementation, the plurality of the supporting elements 2 and the plurality of the conductive elements 4 are without being limited to be made of the conductive rubbers. The plurality of the supporting elements 2 are made of conductive plastics, or the plurality of the supporting elements 2 are made of conductive colloids. The conductive colloids are made of colloidal materials with conductive characteristics by the injection molding technology. The plurality of the conductive elements 4 are made of the conductive plastics, or the plurality of the conductive elements 4 are made of the conductive colloids. In the preferred embodiment, the plurality of the supporting elements 2 and the plurality of the conductive elements 4 together form a plurality of conductive propping elements.

Referring to FIG. 2, in the preferred embodiment, each supporting element 2 is an independent component. Each supporting element 2 has a base portion 20, a connecting portion 21, a top portion 22, an extending portion 23, a protruding portion 24 and a protruding pillar 25. The base portion 20 is fastened in a corresponding mechanism of the elastic element 3. The base portion 20 is shown as a ring shape. An inner periphery of the base portion 20 extends upward to form the connecting portion 21. The connecting portion 21 tapers from bottom to top. The connecting portion 21 extends upward to form the top portion 22. The plurality of the key caps 1 surround the top portions 22 of the plurality of the supporting elements 2.

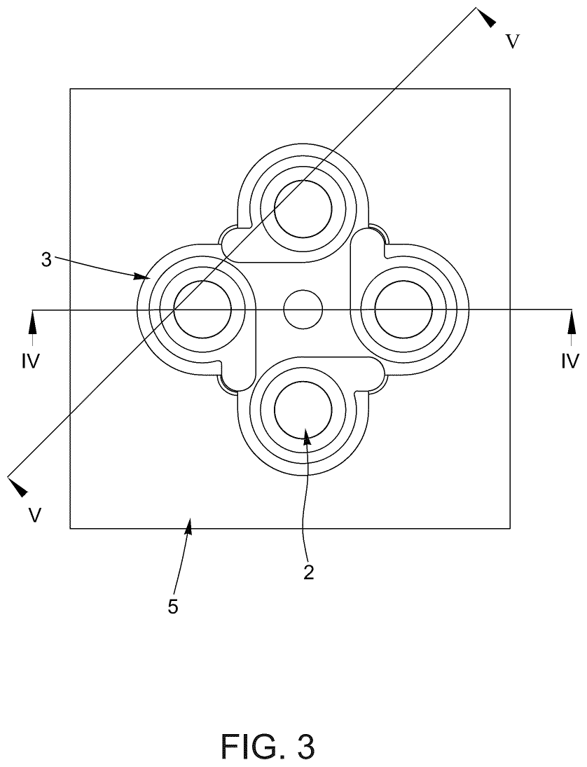

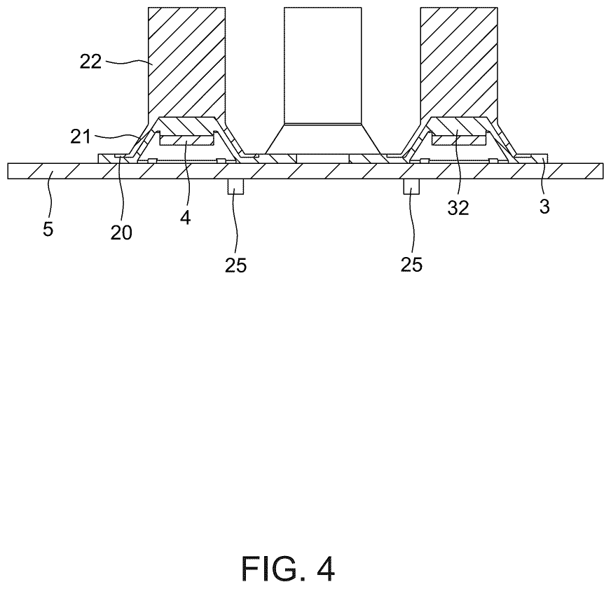

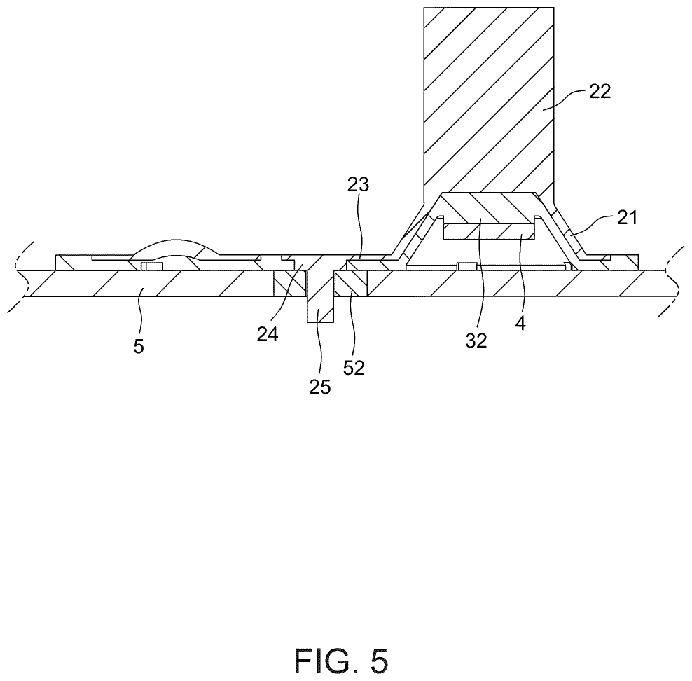

With reference to FIG. 1 to FIG. 5, when each key cap 1 is pressed downward, the key cap 1 together with the top portion 22 of the supporting element 2 moves downward. The connecting portion 21 and the elastic element 3 are deformed. When each key cap 1 is released, the connecting portion 21 and the elastic element 3 are automatically rebounded to be restored to original positions, the connecting portion 21 restores to an original state by virtue of a restoring force of the elastic element 3, and the top portion 22 of the supporting element 2 moves upward to be restored to an initial position.

In the preferred embodiment, the top portion 22 of each supporting element 2 is a columnar structure. A top surface of the top portion 22 of each supporting element 2 is connected with a top of an inner surface of one key cap 1. One side of the base portion 20 extends outward to form the extending portion 23. One side of a bottom surface of the connecting portion 21 extends outward to form the extending portion 23. A lower surface of the extending portion 23 extends downward to form the protruding pillar 25. A tail end of the lower surface of the extending portion 23 extends downward to form the protruding portion 24. A bottom surface of the protruding portion 24 extends downward to form the protruding pillar 25. In the preferred embodiment, the protruding portion 24 is shown as a cylinder shape. A diameter of the protruding portion 24 is bigger than a diameter of the protruding pillar 25. The protruding portion 24 abuts against a top surface of the circuit board 5. The protruding pillar 25 passes through a corresponding mechanism of the circuit board 5 to realize that the supporting element 2 is located to the circuit board 5, and the supporting element 2 is fastened to the circuit board 5.

The elastic element 3 has a plurality of concave portions 31, a plurality of elastic covers 32, and a plurality of first through holes 33 penetrating through a top surface and the bottom surface of the elastic element 3. Several portions of the top surface of the elastic element 3 are recessed downward to form the plurality of the concave portions 31. The base portions 20 and the extending portions 23 of the plurality of the supporting elements 2 are corresponding to the plurality of the concave portions 31. The base portions 20 of the plurality of the supporting elements 2 and the extending portions 23 of the plurality of the supporting elements 2 are matched with the plurality of the concave portions 31. The base portions 20 of the plurality of the supporting elements 2 and the extending portions 23 of the plurality of the supporting elements 2 are disposed to the plurality of the concave portions 31. The plurality of the concave portions 31 separate the plurality of the supporting elements 2 to prevent causing a mutual interference among the plurality of the supporting elements 2.

Middles of top surfaces of the plurality of the concave portions 31 extend upward to form the plurality of the elastic covers 32. The plurality of the elastic covers 32 taper from bottoms of the plurality of the elastic covers 32 to tops of the plurality of the elastic covers 32. The connecting portions 21 of the plurality of the supporting elements 2 are corresponding to the plurality of the elastic covers 32. The connecting portions 21 of the plurality of the supporting elements 2 surround the plurality of the elastic covers 32. The connecting portions 21 of the plurality of the supporting elements 2 are attached to outer surfaces of the plurality of the elastic covers 32. The plurality of the conductive elements 4 are disposed to top surfaces of insides of the plurality of the elastic covers 32. The plurality of the elastic covers 32 separate the connecting portions 21 and the top portions 22 of the plurality of the supporting elements 2, and the plurality of the conductive elements 4 to prevent the mutual interference among the plurality of the supporting elements 2 and the plurality of the conductive elements 4.

In the preferred embodiment, the elastic element 3 is made of an elastic insulating material. The plurality of the elastic covers 32 are bowl-shaped cover bodies. In the concrete implementation, the plurality of the elastic covers 32 are without being limited to be the bowl-shaped cover bodies.

The plurality of the first through holes 33 penetrate through the top surfaces of the plurality of the concave portions 31 and the bottom surface of the elastic element 3. The protruding portions 24 of the plurality of the supporting elements 2 are disposed in the plurality of the first through holes 33. The protruding pillars 25 of the plurality of the supporting elements 2 pass downward through the plurality of the first through holes 33. The protruding pillars 25 of the plurality of the supporting elements 2 project out of the plurality of the first through holes 33.

The circuit board 5 has a plurality of second through holes 51 and a plurality of conductive portions 52. Each conductive portion 52 is shown as an annular shape. The plurality of the conductive portions 52 are disposed in the circuit board 5, and the plurality of the conductive portions 52 are exposed to a top surface and a bottom surface of the circuit board 5. The plurality of the second through holes 51 penetrate through the top surface and the bottom surface of the circuit board 5. Each second through hole 51 is formed at a middle of one conductive portion 52. The plurality of the second through holes 51 penetrate through top surfaces and bottom surfaces of the plurality of the conductive portions 52. The plurality of the first through holes 33 of the elastic element 3 are corresponding to the plurality of the second through holes 51. In the preferred embodiment, walls of the plurality of the second through holes 51 are made of conductive materials, so the plurality of the second through holes 51 are electrically connected with the plurality of the conductive portions 52. The walls of the plurality of the second through holes 51 are designed as inner portions of the plurality of the conductive portions 52, so the walls of the plurality of the second through holes 51 contact with outer portions of the plurality of the conductive portions 52.

The protruding pillars 25 of the plurality of the supporting elements 2 pass through the plurality of the first through holes 33 of the elastic element 3 and the plurality of the second through holes 51. The protruding pillars 25 of the plurality of the supporting elements 2 are fastened in the plurality of the second through holes 51. The protruding pillars 25 of the plurality of the supporting elements 2 are electrically connected with the walls of the plurality of the second through holes 51. The protruding pillars 25 of the plurality of the supporting elements 2 are electrically connected with the plurality of the conductive portions 52. The lower surfaces of the extending portions 23 of the plurality of the supporting elements 2 contacting with top surfaces of the plurality of the conductive portions 52. The protruding pillars 25 of the plurality of the supporting elements 2 contact with the plurality of the conductive portions 52, so the plurality of the supporting elements 2 contact with the circuit board 5, the plurality of the supporting elements 2 are electrically connected with the circuit board 5, and the plurality of the supporting elements 2 and the circuit board 5 are mutually conductive. The protruding pillars 25 of the plurality of the supporting elements 2 are exposed outside to the bottom surface of the circuit board 5. The bottom surfaces of the plurality of the protruding portions 24 of the plurality of the supporting elements 2 contact with the top surfaces of the plurality of the conductive portions 52, so the plurality of the supporting elements 2 contact with the circuit board 5, the plurality of the supporting elements 2 are electrically connected with the circuit board 5, and the plurality of the supporting elements 2 and the circuit board 5 are mutually conductive.

As described above, the plurality of the supporting elements 2 have the conductive characteristics, the bottom surfaces of the plurality of the protruding portions 24 contact with the top surfaces of the plurality of the conductive portions 52, the protruding pillars 25 of the plurality of the supporting elements 2 are fastened in the plurality of the second through holes 51, the walls of the plurality of the second through holes 51 are made of the conductive materials, the plurality of the second through holes 51 are electrically connected with the plurality of the conductive portions 52, and the protruding pillars 25 of the plurality of the supporting elements 2 contact with the plurality of the conductive portions 52, so the plurality of the supporting elements 2 contact with the circuit board 5, the plurality of the supporting elements 2 are electrically connected with the circuit board 5, and the plurality of the supporting elements 2 have the touch sensing capability. When the button structure 100 is pressed downward, the plurality of the conductive elements 4 contact with the circuit board 5, and the plurality of the conductive elements 4 are electrically connected with the circuit board 5, when the button structure 100 is touched, the plurality of the supporting elements 2 are electrically connected with the circuit board 5 to make the plurality of the supporting elements 2 have the touch sensing capability. Furthermore, the elastic element 3 separates the plurality of the supporting elements 2 and the plurality of the conductive elements 4 to prevent causing the mutual interference among the plurality of the supporting elements 2 and the plurality of the conductive elements 4, the plurality of the concave portions 31 separate the plurality of the supporting elements 2 to prevent causing the mutual interference among the plurality of the supporting elements 2, and the plurality of the elastic covers 32 separate the connecting portions 21 and the top portions 22 of the plurality of the supporting elements 2, and the plurality of the conductive elements 4 to prevent causing the mutual interference among the plurality of the supporting elements 2 and the plurality of the conductive elements 4. As a result, the button structure 100 prevents a mutual interference among electronic circuits and improves a sensitivity of the button structure 100 which has the touch sensing capability.

What is claimed is:

1. A button structure, comprising:
a plurality of supporting elements, each supporting element having a base portion, the base portion extending upward to form a connecting portion, the connecting portion extending upward to form a top portion;
an elastic element disposed to bottom surfaces of the plurality of the supporting elements, several portions of a top surface of the elastic element being recessed downward to form a plurality of concave portions, the base portions of the plurality of the supporting elements being disposed to the plurality of the concave portions, middles of top surfaces of the plurality of the concave portions extending upward to form a plurality of elastic covers, the connecting portions of the plurality of the supporting elements surrounding the plurality of the elastic covers;
a plurality of conductive elements disposed to top surfaces of insides of the plurality of the elastic covers;
a circuit board disposed to a bottom surface of the elastic element, the plurality of the conductive elements being disposed between the elastic element and the circuit board; and
a plurality of key caps mounted around the plurality of the supporting elements, the plurality of the key caps surrounding the top portions of the plurality of the supporting elements.

2. The button structure as claimed in claim 1, wherein one side of the base portion extends outward to form an extending portion, the base portions and the extending portions of the plurality of the supporting elements are matched with the plurality of the concave portions, the extending portions of the plurality of the supporting elements are disposed to the plurality of the concave portions, a lower surface of the extending portion extends downward to form a protruding pillar.

3. The button structure as claimed in claim 2, wherein the elastic element has a plurality of first through holes penetrating through the top surfaces of the plurality of the concave portions and the bottom surface of the elastic element, the protruding pillars of the plurality of the supporting elements pass through the plurality of the first through holes.

4. The button structure as claimed in claim 3, wherein the circuit board has a plurality of second through holes and a plurality of conductive portions, the plurality of the conductive portions are disposed in the circuit board, and the plurality of the conductive portions are exposed to a top surface of the circuit board, the plurality of the second through holes penetrate through the top surface of the circuit board, each second through hole is formed at a middle of one conductive portion, the plurality of the second through holes penetrate through top surfaces of the plurality of the conductive portions, the plurality of the first through holes of the elastic element are corresponding to the plurality of the second through holes, the protruding pillars of the plurality of the supporting elements pass through the plurality of the second through holes.

5. The button structure as claimed in claim 4, wherein a tail end of the lower surface of the extending portion extends downward to form a protruding portion, a bottom surface of the protruding portion extends downward to form the protruding pillar, a diameter of the protruding portion is bigger than a diameter of the protruding pillar, the bottom surfaces of the plurality of the protruding portions contact with top surfaces of the plurality of the conductive portions, the protruding portions of the plurality of the supporting elements are disposed in the plurality of the first through holes.

6. The button structure as claimed in claim 4, wherein walls of the plurality of the second through holes are made of conductive materials.

7. The button structure as claimed in claim 1, wherein the plurality of the supporting elements are made of conductive rubbers, the plurality of the conductive elements are made of the conductive rubbers.

8. The button structure as claimed in claim 1, wherein the elastic element is made of an elastic insulating material.

9. The button structure as claimed in claim 1, wherein the plurality of the elastic covers are bowl-shaped cover bodies.

10. The button structure as claimed in claim 1, wherein the connecting portion tapers from bottom to top, the plurality of the elastic covers taper from bottoms of the plurality of the elastic covers to tops of the plurality of the elastic covers, the connecting portions of the plurality of the supporting elements are attached to outer surfaces of the plurality of the elastic covers, the plurality of the conductive elements are disposed to top surfaces of insides of the plurality of the elastic covers.

11. The button structure as claimed in claim 1, wherein the base portion is shown as a ring shape, an inner periphery of the base portion extends upward to form the connecting portion.

12. The button structure as claimed in claim 1, wherein the plurality of the supporting elements contact with the circuit board, the plurality of the supporting elements are electrically connected with the circuit board.

13. A button structure, comprising:
a plurality of supporting elements, each supporting element having a connecting portion, the connecting portion extending upward to form a top portion, one side of a bottom surface of the connecting portion extending outward to form an extending portion, a lower surface of the extending portion extending downward to form a protruding pillar;
an elastic element disposed to bottom surfaces of the plurality of the supporting elements, the elastic element having a plurality of first through holes penetrating through a top surface and a bottom surface of the elastic element, the protruding pillars of the plurality of the supporting elements passing through the plurality of the first through holes;
a circuit board disposed to the bottom surface of the elastic element, the circuit board having a plurality of second through holes and a plurality of conductive portions, the plurality of the conductive portions being disposed in the circuit board, and the plurality of the conductive portions being exposed to a top surface of the circuit board, the plurality of the second through holes penetrating through the top surface of the circuit board, each second through hole being formed at a middle of one conductive portion, the plurality of the second through holes penetrating through top surfaces of the plurality of the conductive portions, the plurality of the first through holes being corresponding to the plurality of the second through holes, the protruding pillars of the plurality of the supporting elements passing through the plurality of the first through holes and the plurality of the second through holes, the lower surfaces of the extending portions of the plurality of the supporting elements contacting with top surfaces of the plurality of the conductive portions; and
a plurality of key caps surrounding the top portions of the plurality of the supporting elements.

14. The button structure as claimed in claim 13, wherein each supporting element has a base portion, the base portion extends upward to form the connecting portion, one side of the base portion extends outward to form the extending portion, several portions of a top surface of the elastic element are recessed downward to form a plurality of concave portions, the base portions and the extending portions of the plurality of the supporting elements are corresponding to the plurality of the concave portions, the base portions of the plurality of the supporting elements and the extending portions of the plurality of the supporting elements are matched with the plurality of the concave portions, the base portions of the plurality of the supporting elements and the extending portions of the plurality of the supporting elements are disposed to the plurality of the concave portions.

15. The button structure as claimed in claim 14, wherein top surfaces of the plurality of the concave portions extend upward to form a plurality of elastic covers, the connecting portions of the plurality of the supporting elements are corresponding to the plurality of the elastic covers, the connecting portions of the plurality of the supporting elements surround the plurality of the elastic covers, the connecting portions of the plurality of the supporting elements are attached to outer surfaces of the plurality of the elastic covers.

16. The button structure as claimed in claim 15, wherein the plurality of the elastic covers are bowl-shaped cover bodies.

17. The button structure as claimed in claim 13, wherein walls of the plurality of the second through holes are made of conductive materials, so the plurality of the second through holes are electrically connected with the plurality of the conductive portions, the protruding pillars of the plurality of the supporting elements are fastened in the plurality of the second through holes, the protruding pillars of the plurality of the supporting elements are electrically connected with the plurality of the conductive portions.

18. The button structure as claimed in claim 13, wherein a tail end of the lower surface of the extending portion extends downward to form a protruding portion, a bottom surface of the protruding portion extends downward to form the protruding pillar, a diameter of the protruding portion is bigger than a diameter of the protruding pillar, the bottom surfaces of the plurality of the protruding portions contact with the top surfaces of the plurality of the conductive portions, the protruding portions of the plurality of the supporting elements are disposed in the plurality of the first through holes.

19. A button structure, comprising:
a plurality of conductive supporting elements, each conductive supporting element having a connecting portion, the connecting portion extending upward to form a top portion, one side of the connecting portion extending outward to form an extending portion, a lower surface of the extending portion extending downward to form a protruding pillar;
an insulative elastic element, the plurality of the conductive supporting elements being integrated with the insulative elastic element by virtue of an injection molding technology, the insulative elastic element being disposed to bottom surfaces of the plurality of the conductive supporting elements, a top of the insulative elastic element projecting into the plurality of the conductive supporting elements, the insulative elastic element having a plurality of first through holes penetrating through a top surface and a bottom surface of the insulative elastic element, the protruding pillars of the plurality of the conductive supporting elements passing through the plurality of the first through holes;
a circuit board disposed to the bottom surface of the insulative elastic element, the circuit board having a plurality of second through holes penetrating through a top surface of the circuit board, the plurality of the first through holes being corresponding to the plurality of the second through holes, the protruding pillars of the plurality of the supporting elements passing through the plurality of the first through holes and the plurality of the second through holes, the plurality of the second through holes being made of conductive materials, the protruding pillars of the plurality of the conductive supporting elements being electrically connected with the plurality of the second through holes; and
a plurality of key caps surrounding the top portions of the plurality of the insulative supporting elements.
